(19) United States
(12) Patent Application Publication
(10) Pub. No.: US 2007/0216852 A1
(43) Pub. Date: Sep. 20, 2007

(54) Eyeglasses assembly

(76) Inventor: Paul Chen, San Marino, CA (US)

Correspondence Address: KIRSCHSTEIN, OTTINGER, ISRAEL;& SCHIFFMILLER, P.C., 489 FIFTH AVENUE, NEW YORK, NY, 10017, US

(21) Appl. No.: 11/384,644

(22) Filed: Mar. 20, 2006

(51) Int. Cl. G02C 5/00

(52) U.S. Cl. 351/41

(57) ABSTRACT

An eyeglasses assembly includes: a main lens unit provided with a first connecting piece; a pivot pin; a temple piece pivoted to the first connecting piece through the pivot pin; and a secondary lens unit overlapping the main lens unit and provided with a second connecting piece that is magnetically attracted to the pivot pin so as to be detachably attached to the first connecting piece.

### BACKGROUND OF THE INVENTION

1. Field of the Invention

The invention relates to an eyeglasses assembly, more particularly to an eyeglasses assembly including a main lens unit and a secondary lens unit attracted to a front side of the main lens unit.

2. Description of the Related Art

Referring to FIGS. 1 and 2, a conventional eyeglasses assembly 1 is shown to include a main lens unit 11 and a secondary lens unit 12. The main lens unit 11 includes a main frame 111, a pair of main lenses 112 mounted in the main frame 111, a pair of temples 113 that are respectively pivoted to two ends of the main frame 111 through a pair of pivot pins 114, and a pair of main magnetic members 115 respectively embedded at top sides of the temples 113. The secondary lens unit 12 includes a secondary frame 121 disposed at a front side of the main frame 111, a pair of secondary lenses 122 mounted in the secondary frame 121, and a pair of arms 123 provided with a pair of second magnetic members 124 that are magnetically and respectively attracted to the main magnetic members 115.

The conventional eyeglasses assembly 1 is disadvantageous in that it requires the main magnetic members 115 and formation of recesses in the temples 113 for mounting of the main magnetic members 115.

### SUMMARY OF THE INVENTION

Therefore, the object of the present invention is to provide an eyeglasses assembly that can overcome the aforesaid drawbacks associated with the prior art.

Accordingly, an eyeglasses assembly of this invention comprises: a main lens unit provided with a first connecting piece; a pivot pin; a temple piece pivoted to the first connecting piece through the pivot pin; and a secondary lens unit overlapping the main lens unit and provided with a second connecting piece that is magnetically attracted to the pivot pin so as to be detachably attached to the first connecting piece.

### BRIEF DESCRIPTION OF THE DRAWINGS

Other features and advantages of the present invention will be come apparent in the following detailed description of the preferred embodiment with reference to the accompanying drawings, of which:

FIG. 1 is a fragmentary exploded perspective view of a conventional eyeglasses assembly;

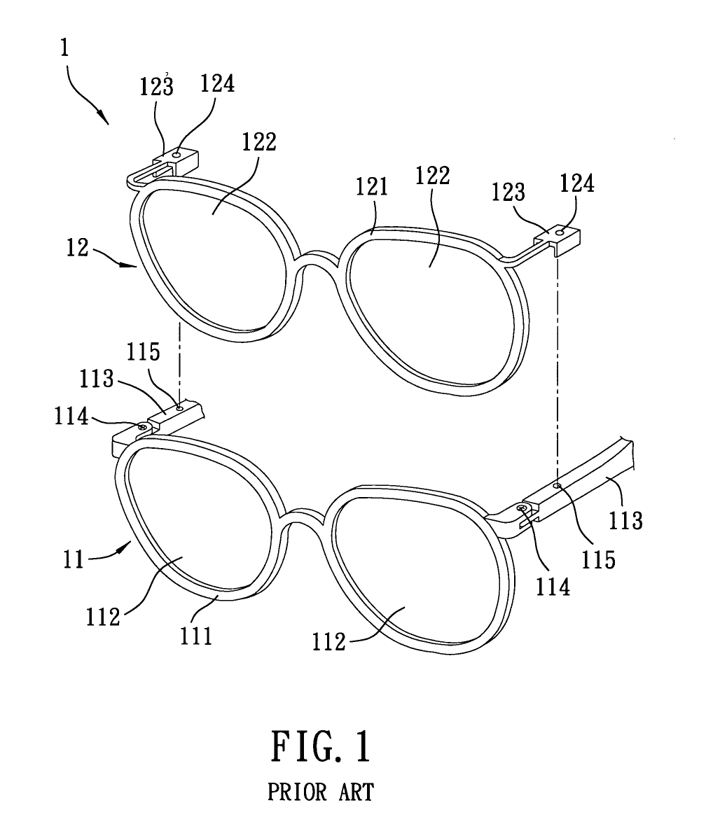

FIG. 2 is a fragmentary assembled sectional view of the conventional eyeglasses assembly;

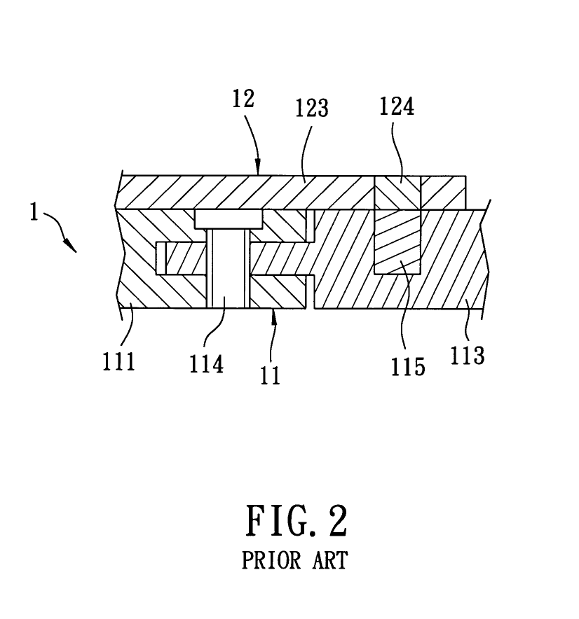

FIG. 3 is a fragmentary exploded perspective view of the preferred embodiment of an eyeglasses assembly according to the present invention; and

FIG. 4 is a fragmentary assembled sectional view of the preferred embodiment.

### DETAILED DESCRIPTION OF THE PREFERRED EMBODIMENT

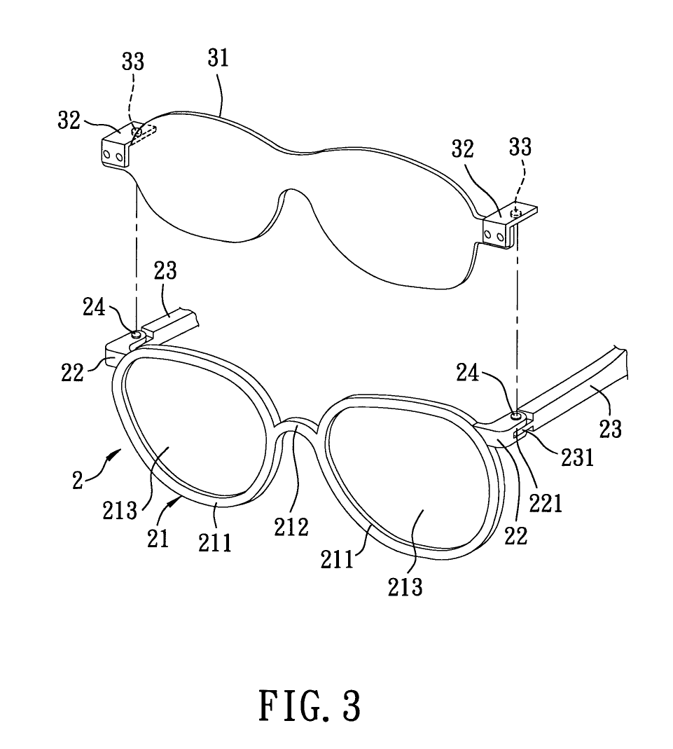

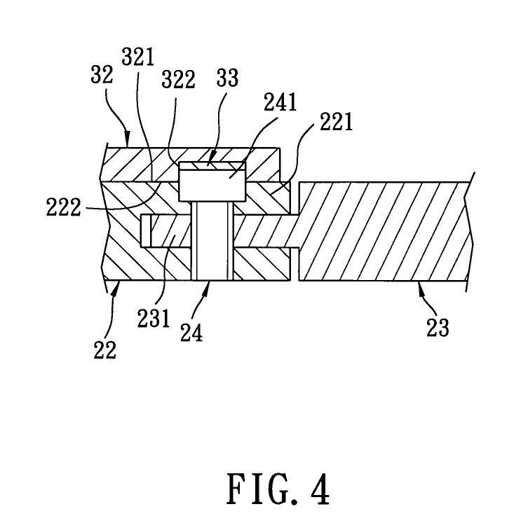

As shown in FIGS. 3 and 4, the preferred embodiment of an eyeglasses assembly 2 according to the present invention includes: a main lens unit 21 provided with a pair of first connecting pieces 22; a pair of pivot pins 24; a pair of temple pieces 23 pivoted to the first connecting pieces 22 through the pivot pins 24, respectively; and a secondary lens unit 31 overlapping the main lens unit 21 and provided with a pair of second connecting pieces 32 that are magnetically and respectively attracted to the pivot pins 24 so as to be detachably and respectively attached to the first connecting pieces 22.

The main lens unit 21 includes a pair of left and right lens frames 211, a bridge 212 connecting the left and right lens frames 211, and a pair of lenses 213, each of which is mounted in a respective one of the lens frames 211. Alternatively, the main lens unit 21 may include a single frame or a top frame bar (not shown). Therefore, the main lens unit 21 is not limited to the embodiment disclosed herein. In this embodiment, the secondary lens unit 31 is a single-piece ultra-violet protection sunglass lens.

Each of the first connecting pieces 22 has a top surface 222. Each of the pivot pins 24 has a head portion 241 that protrudes upwardly from the top surface 222 of the respective first connecting piece 22. Each of the second connecting pieces 32 has a lower surface 321 and a recess 322 that is indented inwardly from the lower surface 321, and is provided with an engaging piece 33 that is mounted in the recess 322. The head portion 241 of each of the pivot pins 24 extends into the recess 322 in the respective second connecting piece 32, and is magnetically attracted to the engaging piece 33 in the recess 322 in the respective second connecting piece 32.

To provide sufficient engagement between the main and secondary lens units 21, 31, each of the pivot pin 24 and the engaging piece 33 is preferably magnetic. Alternatively, the engaging piece 33 is a magnet, whereas the pivot pin 24 is made from a material, such as iron, that is magnetically attractive.

Each of the first connecting pieces 22 is L-shaped, and has a bifurcated end 221 defining an inserting slot. Each of the temple pieces 23 has a connecting end formed with an insert 231 reduced in cross-section therefrom and extending into the inserting slot in the bifurcated end 221 of a respective one of the first connecting pieces 22. Each of the pivot pins 24 extends through the insert 231 of a respective one of the temple pieces 23 and the bifurcated end 221 of the respective one of the first connecting pieces 22.

By virtue of the magnetic engagement between each pivot pin 24 and the respective engaging piece 33 of the eyeglasses assembly 2 of this invention, formation of the recesses in the temples 113 and the main magnetic members 115 as required in the aforesaid conventional eyeglasses assembly may be dispensed with.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. An eyeglasses assembly comprising:
a main lens unit provided with a first connecting piece;
a pivot pin;
a temple piece pivoted to said first connecting piece through said pivot pin; and
a secondary lens unit overlapping said main lens unit and provided with a second connecting piece that is magnetically attracted to said pivot pin so as to be detachably attached to said first connecting piece.

2. The eyeglasses assembly as claimed in claim 1, wherein said first connecting piece has a top surface, said pivot pin having a head portion that protrudes upwardly from said top surface of said first connecting piece, said second connecting piece having a lower surface and a recess that is indented inwardly from said lower surface, and being provided with an engaging piece that is mounted in said recess, said head portion of said pivot pin extending into said recess in said second connecting piece and being magnetically attracted to said engaging piece.

3. The eyeglasses assembly as claimed in claim 2, wherein each of said pivot pin and said engaging piece is magnetic.
